(19) United States
(12) Patent Application Publication
(10) Pub. No.: US 2018/0297220 A1
(43) Pub. Date: Oct. 18, 2018

(54) SHAVING RAZOR SYSTEM

(71) Applicant: The Gillette Company LLC, Boston, MA (US)

(72) Inventor: Matthew James Hodgson, Ramsbury (GB)

(21) Appl. No.: 15/951,273

(22) Filed: Apr. 12, 2018

Related U.S. Application Data
(60) Provisional application No. 62/486,611, filed on Apr. 18, 2017.

(51) Int. Cl. B26B 21/40; B26B 21/52

(52) U.S. Cl. CPC B26B 21/4031; B26B 21/522

(57) ABSTRACT

A shaving razor system with a handle having a center longitudinal axis. A shaving cartridge is mounted to the handle. The shaving cartridge has a guard and a cap defining a shaving plane and at least one blade having a cutting edge between the guard and cap. The shaving razor cartridge has a neutral position where the shave plane is within seven degrees of being perpendicular to the center longitudinal axis.

### FIELD OF THE INVENTION

The present invention relates to wet shaving safety razors and more particularly to shaving razor systems that have a shaving razor cartridge mounted to an ergonomically formed handle for shaving another person's face.

### BACKGROUND OF THE INVENTION

In general, a cartridge or blade unit of a safety razor has at least one blade with a cutting edge which is moved across the surface of the skin being shaved by means of a handle to which the cartridge is attached. Some shaving razors are provided with a spring biased cartridge that pivots relative to the handle to follow the contours of the skin during shaving. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled.

Razor blade assemblies have been disclosed wherein cutting-edge portions of the blade members are held between skin engaging surfaces which are generally referred to as the guard and cap of the razor blade assembly. The guard contacts the skin in front of the blade member(s) and the cap contacts the skin behind the blade member(s) during a shaving stroke. The cap and guard may aid in establishing the so-called “shaving geometry”, i.e., the parameters which determine the blade orientation and position relative to the skin during shaving, which in turn have a strong influence on the shaving performance and efficacy of the razor. The cap may comprise a water leachable shaving aid to reduce drag and improve comfort. The guard may be generally rigid, for example formed integrally with a frame or platform structure which provides a support for the blades. Guards may also comprise softer elastomeric materials to improve skin stretching.

Personal care givers often care for individuals who are unable to shave themselves because of decreased mental and/or physical capacity often brought about by chronic age, injury, or various degenerative diseases. The task of shaving another person requires extreme care, patience, coordination and spatial awareness to avoid cutting the person being shaved. In the United States, barbers are licensed and often have years of experience shaving other people. However, close family members and professional care givers are much less familiar with shaving techniques for shaving another person. Furthermore, barbers typically use a straight edge razor, which would be very dangerous for a personal care giver or family member to attempt using on another person without proper training. Wet safety razor shaving systems have been enhanced for over one hundred years for self-application. However, these designs are suboptimal for shaving another person.

Thus, there is a need for a shaving razor cartridge mounted to an ergonomic handle to allow for proper control and manipulation for shaving another person's face.

### SUMMARY OF THE INVENTION

In one aspect, the invention features, in general a shaving razor system with a handle having a center longitudinal axis. A shaving cartridge is mounted to the handle. The shaving cartridge has a guard and a cap defining a shaving plane and at least one blade having a cutting edge between the guard and cap. The shaving razor cartridge has a neutral position with the shave plane within seven degrees of being perpendicular to the center longitudinal axis.

In another aspect, the invention features, in general a shaving razor system with a handle having a center longitudinal axis. A shaving cartridge is mounted to the handle. The shaving cartridge has a guard and a cap defining a shaving plane and at least one blade having a cutting edge between the guard and cap. The center longitudinal axis of the handle intersects the shave plane less than 10 mm from the cutting edge of the blade.

### BRIEF DESCRIPTION OF THE DRAWINGS

Other features and advantages of the present invention, as well as the invention itself, can be more fully understood from the following description of the various embodiments, when read together with the accompanying drawings, in which:

FIGS. 1A and 1B are side views of a person's face being shaved by another person.

FIG. 2 is a section view of a T-shaped double edge razor.

FIG. 3 is a perspective view of a shaving razor system according to one possible embodiment of the present invention.

FIG. 4A is a side view of a person's face being shaved by another person with the shaving razor system of FIG. 3.

FIG. 4B is a cross section view of the shaving razor system of FIG. 3, taken generally along the line 4B-4B of FIG. 3.

FIG. 5A is a schematic view of a shaving razor cartridge of the shaving razor system of FIG. 3 shown in a neutral pivot position.

FIG. 5B is a schematic view of a shaving razor cartridge of the shaving razor system of FIG. 3 shown in a forward pivot position.

FIG. 5C is a schematic view of a shaving razor cartridge of the shaving razor system of FIG. 3 shown in a rearward pivot position.

FIGS. 6A and 6B, are side views of the shaving razor system of FIG. 3 on a grid.

### DETAILED DESCRIPTION OF THE INVENTION

When shaving yourself a razor handle is typically held at an angle between 30 degrees and parallel to the place of the surface of the skin being shaved, either in the form of downward strokes or upstrokes. This arrangement is generally comfortable and intuitive for the user and also provides good visibility when shaving in front of a mirror. The hand is kept a good distance from the shave surface, meaning that the reflected view of the area being shaved is not obscured by the shaver's own hand. This scenario has shaped the way razors have been designed and optimized for over one hundred years. However, the positional relationship between a shaving razor handle and person being shaved (subject) is very different compared to self-shaving.

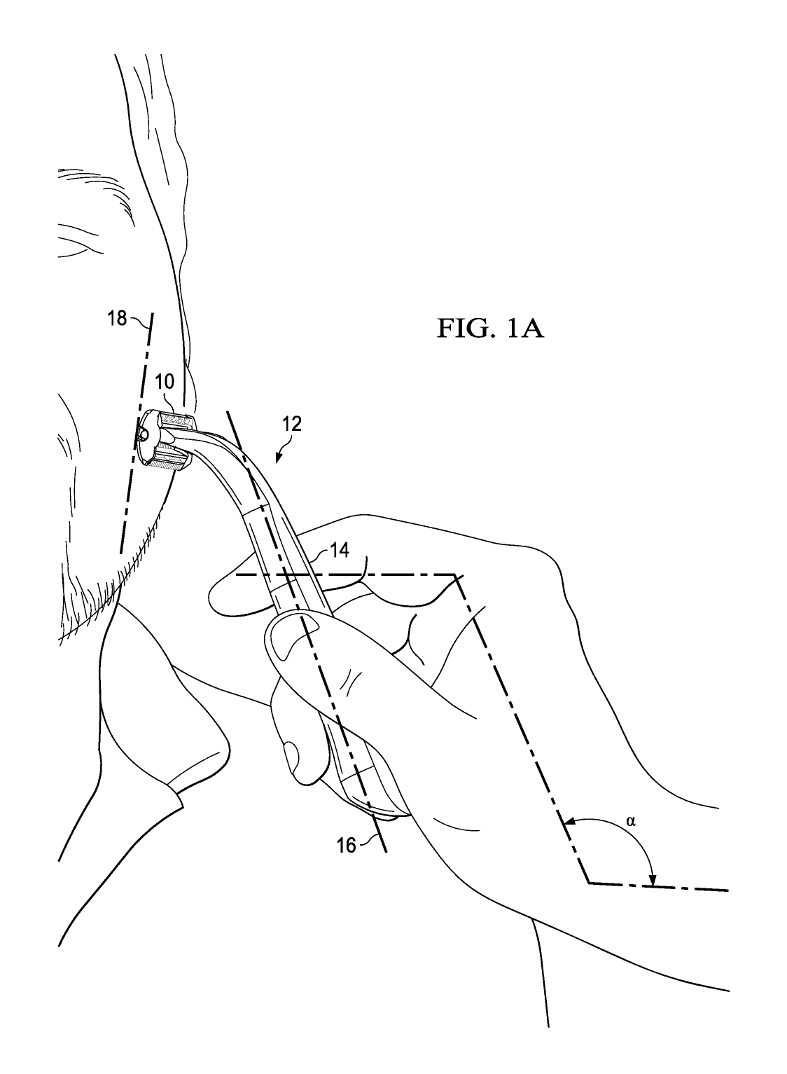

Referring to FIGS. 1A and 1B, side views of a person's face being shaved by another person are illustrated. A shaving razor cartridge 10 may be mounted to an end of a shaving razor handle 12 that has an elongated gripping portion 14 with a longitudinal axis 16. The shaving razor cartridge 10 may define a shaving plane 18. The typical self-shave model becomes no longer valid when shaving another person because it creates several problems. When shaving another person, the person being shaved (i.e., the subject), is commonly in a sitting or lying down position while the person performing the shaving function (i.e., the care giver) is standing. The relative position of the care giver and subject creates a relatively low face and neck position, making positioning the shaving razor cartridge 10 utilizing a conventional grip and stroke (as shown in FIG. 1A) far more difficult and uncomfortable, as illustrated by the exaggerated wrist angle “a”. The hand may be generally parallel to the handle axis 16, thus putting the wrist in a generally transverse position relative to the hand.

Other handle grips may be used, as illustrated in FIG. 1B. For example, the handle 14 may approach the subject's face at a higher razor handle angle closer that may be generally perpendicular to the skin being shaved. The wrist angle may create a more neutral position, which may result in a more comfortable position for the care giver. However, this position also leads to a poor blade to skin angle resulting in poor shaving performance (e.g., efficiency and safety). For example, the shave plane 18 does not conform very well to the surface of the skin being shaved. Furthermore, the cartridge 10 may pivot to a full pivot position prematurely as the cartridge 10 is placed onto the skin. Accordingly, the skin conforming and safety benefits of a pivoting cartridge are largely mitigated.

Current razor handle designs are also not optimal because the subject's relatively low position results in the care giver having to bend over the subject to improve visibility and access to the area to be shaved. In this scenario, there are many areas of the face and neck that are significantly more difficult to shave, such as, the underside of the jaw and the area where the neck meets the jaw. The raising or turning of the subject's head is often not possible when shaving someone with diminished physical or mental capacity. Barbers typically solve this problem by seating his subject in a chair that is able to recline, swivel and change height to achieve the optimum physical setup. This is often not practicable when shaving someone at home or in a care giver's facility. In addition, for many men in care with reduced mental capacity, sitting still during the shaving process is not always possible. Unpredictable movements present a serious safety risk and makes shaving the subject significantly more challenging.

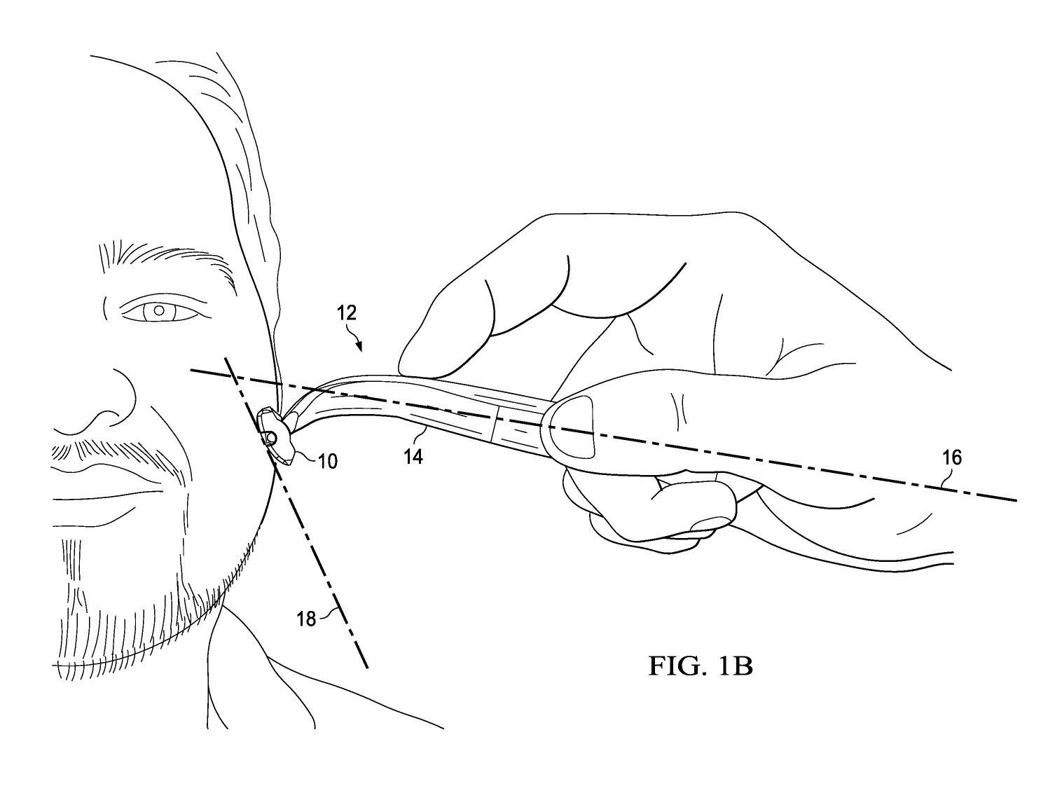

Referring to FIG. 2, a section view of a common T-shaped double edge safety razor 20 is shown. A cap 22 and a guard 24 may establish a shave plane 26 that is tangent to the cap 22 and the guard 24. A blade 28 having a cutting edge 30 may be positioned on the shave plane 26. The safety razor 20 may have a handle 32 with a center longitudinal axis 34. The position of the center longitudinal axis relative to the shave plane 26 and the shave plane 26 establishes how the safety razor 20 must approach the skin during a shaving stroke. For example, the shave plane 22 may intersect the center longitudinal axis 34 of the handle 32 at an included angle “β” of about 135 degrees. As will be explained in greater detail below, it is believed, without being held to theory that the intersection of the shave plane and center longitudinal axis of a shaving razor should be closer to perpendicular for shaving another person (i.e., third party shaving).

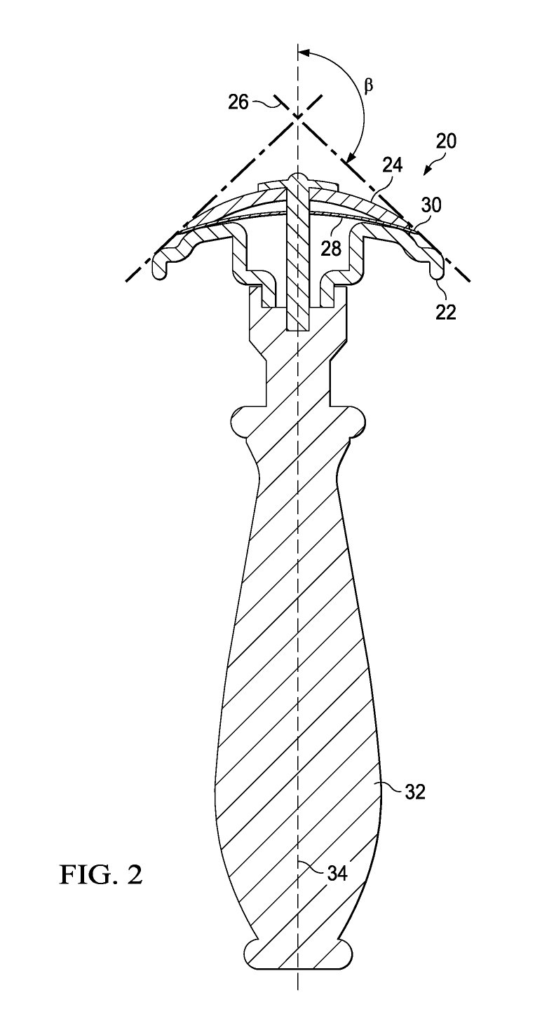

Referring to FIG. 3, a perspective view of a shaving razor system 40 is shown. A shaving razor cartridge 42 may be mounted to a handle 44. In certain embodiments, the handle 44 may be generally straight. The shaving razor cartridge 42 may be removable or permanently mounted to the handle 44. For example, the shaving razor cartridge 40 may be mounted detachably on a handle 44 to enable the shaving razor cartridge 42 to be replaced by a fresh shaving razor cartridge 42 when the blade sharpness has diminished to an unsatisfactory level, or it may be attached permanently to the handle 44 with the intention that the entire razor be discarded when the blade or blades have become dulled. For third party shaving, it may be advantageous to have a removable cartridge 42, which can be discarded in a sharps container separately from the handle 44 to reduce the cost of waste removal. The cartridge 42 may be discarded after every shave for sanitary purposes. The cartridge 42 may be mounted to a coupler 46 having finger pad 48 to facilitate proper orientation a user's hand. The finger pad 46 may define an opening 50. In certain embodiments, the opening 50 may extend completely through the coupler 46. One end of the coupler 46 may have docking a mechanism 52 (e.g., a pair of pins) for attaching the cartridge 42.

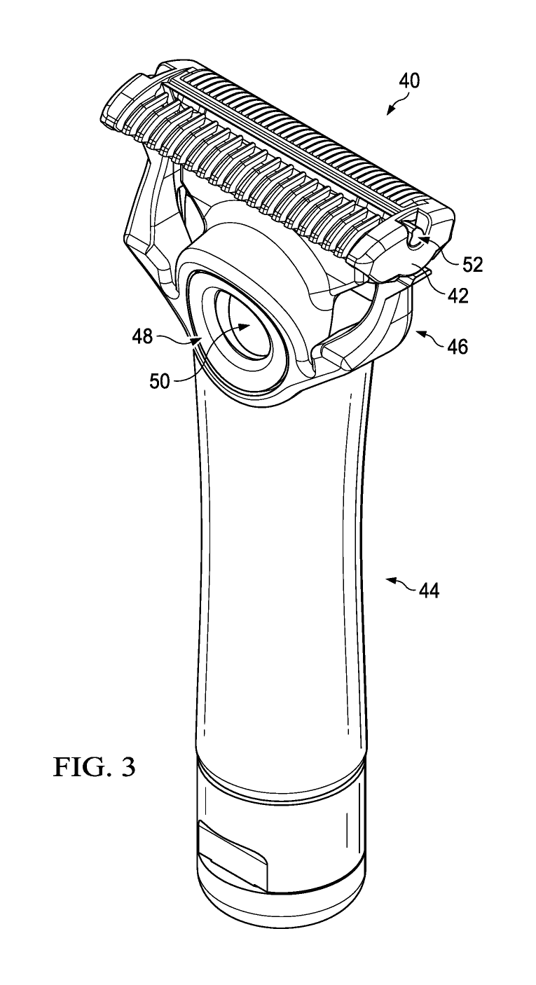

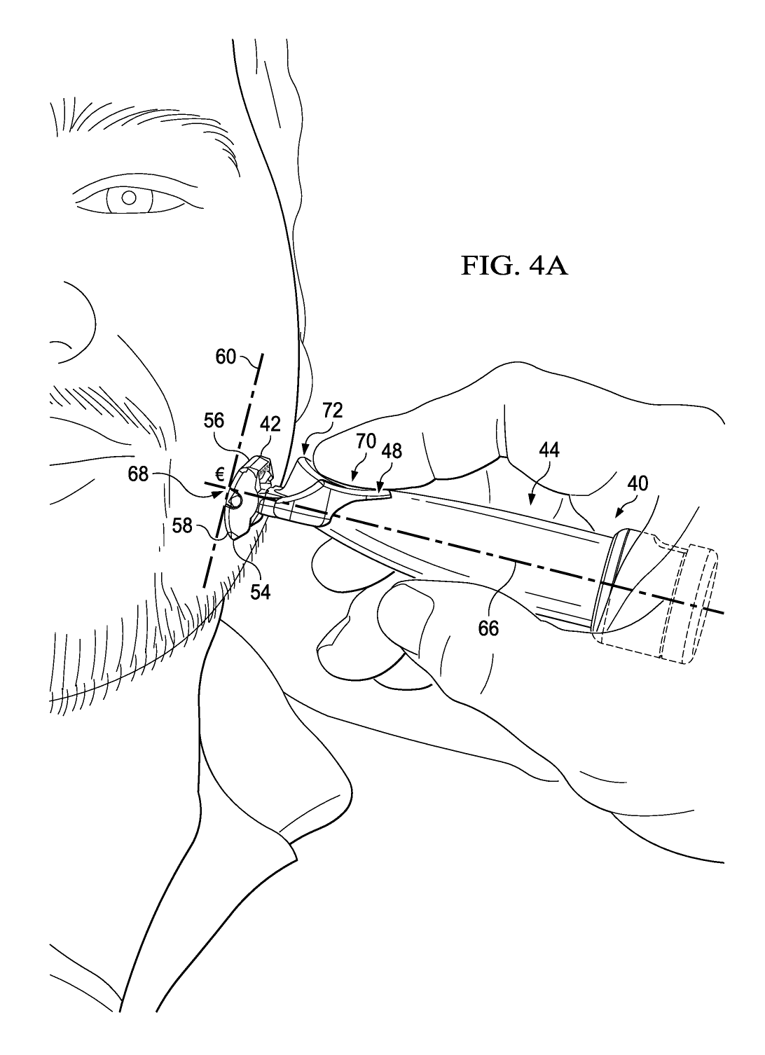

Referring to FIG. 4A, a side view of a person's face being shaved by another person with the shaving razor system 40 is illustrated. In addition, FIG. 4B illustrates a cross section view of the shaving razor system 40, taken generally along the line 4B-4B of FIG. 3. The shaving direction of the shaving razor system 40 is represented by arrow “A”. The shaving razor cartridge 42 may have a guard 54, a cap 56 and a blade 58 between the guard 54 and the cap 56. The blade 58 may have a cutting edge 55. The shaving razor cartridge 42 may have a neutral position (e.g., resting position) with a shave plane 60 within seven degrees of perpendicular to a center longitudinal axis 66 of the handle 44 and more preferably within five degrees. For example, in certain embodiments, the shave plane 60 may intersect the center longitudinal axis 66 of the handle 44 at an angle “€” of about 85 degrees to about 95 degrees (i.e., within 5 degrees of perpendicular). It is believed, without being held to theory that the intersection of the shave plane 60 and center longitudinal axis 66 of a shaving razor handle 44 should be closer to perpendicular (i.e., 90 degrees) for shaving another person (i.e., third party shaving) for improved user ergonomics and proper positioning of the shaving razor cartridge 42 on the skin of the person being shaved. The position of the shave plane 60 relative to the center longitudinal axis 66 of the handle 44 facilitates a neutral and more intuitive position of a care taker's hand as the shaving razor cartridge 42 is pressed against the surface of the skin to be shaved. Furthermore, the relative position of the shave plane 60 and the center longitudinal axis 66 allows the shaving razor cartridge 42 to pivot over its full range of movement, thus facilitating the shaving razor cartridge 42 to follow the contours of the skin during a shaving stroke. In certain embodiments, the center longitudinal axis 66 may pass through a pivot axis 68 of the shaving razor cartridge 42.

The position of the finger pad 48 position may also give the care taker a greater feeling of control and response. For example, the finger pad 48 facilitates the position of a user's finger to point toward the shave plane 60 and in the direction of the shaving razor cartridge 42. The finger pad 48 may have a concave top surface 70 with a leading edge 72 that is positioned about 3 mm to about 20 mm and preferably 5 mm to about 15 mm from the intersection of the shaving plane 60 and the center longitudinal axis 66. The finger pad 48 may be generally parallel to the center longitudinal axis 66 of the handle 44 and transverse to the shaving plane 60. Accordingly, the bottom surface of the finger may be directed toward the center longitudinal axis 66 and pointing toward the shave plane 60.

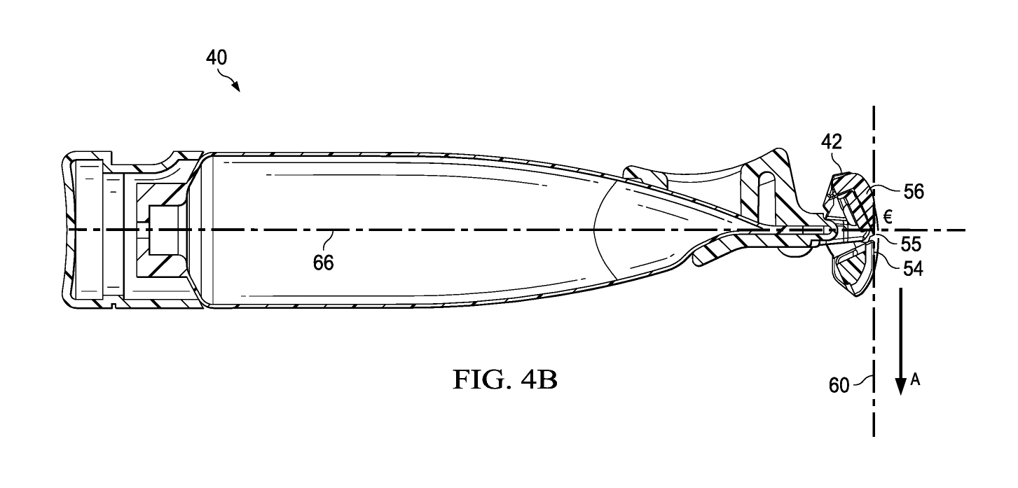

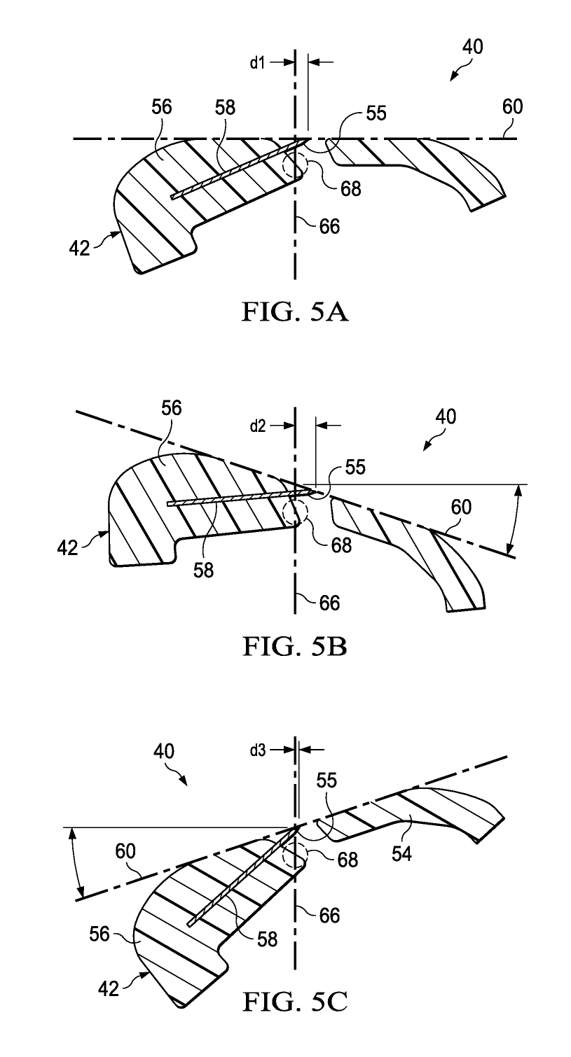

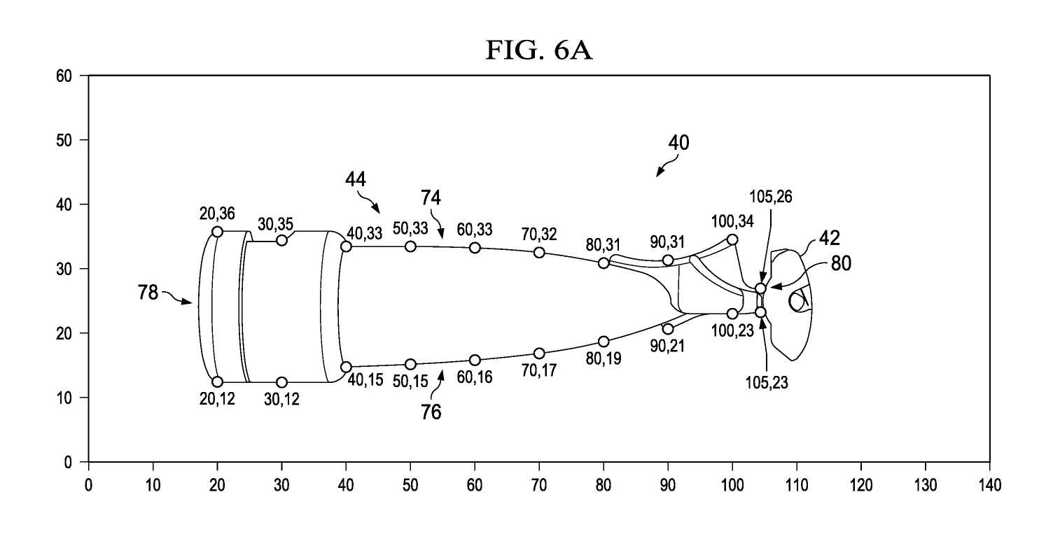

Referring to FIGS. 5A, 5B and 5C schematic views of the shaving razor system 40 with the shaving razor cartridge 42 is shown in a neutral, a forward and a rearward pivot position, respectively. In certain embodiments, the center longitudinal axis 66 may pass between a point on the cap 56 tangent to the shave plane 60 and a point on the guard 54 tangent to the shave plane 60 in either the neutral, forward or rearward pivot position. The center longitudinal axis 66 may intersect the shave plane 60 very close to the cutting edge of the blade (e.g., between the guard and the cap). For example, center longitudinal axis 66 may intersect the shave plane 60 a horizontal distance d1 less than 25 mm from the cutting edge 55. In certain embodiments, center longitudinal axis 66 may intersect the shave plane 60 about 0 mm to about 20 mm from the cutting edge 55. As the shaving razor 42 cartridge pivots, position at which the center longitudinal axis 66 intersects the shave plane 60 may change. For example, the shaving razor cartridge 42 may pivot to the forward pivot position approximately 18.5 degrees, causing the position at which the center longitudinal axis 66 intersects the shave plane 60 to move closer to the cap. As the shaving razor cartridge 42 pivots to the rearward pivot position approximately 18.5 degrees, the position at which the center longitudinal axis 66 intersects the shave plane 60 may move closer to the cap 56 (FIG. 5C). In certain embodiments, the intersection of the center longitudinal axis 66 and the shave plane 60 may remain between the cap 56 and the guard 54 as the shaving razor cartridge 42 pivots from the forward position and the rearward position giving the user improved control. The shaving razor cartridge 42 may have an ultimate forward pivot position of 25 degrees from the neutral pivot position, with a more preferable ultimate forward pivot position within 20 degrees from the neutral pivot position (i.e., 0 to 20 degrees). The shaving razor cartridge 42 may have an ultimate rearward pivot position of 25 degrees from the neutral pivot position, with a more preferable ultimate rearward pivot position within 20 degrees from the neutral pivot position (i.e., 0 to 20 degrees).

The center longitudinal axis 66 may pass through the blade 58. In certain embodiments, the center longitudinal axis 66 may be positioned at a horizontal distance “d1, in a neutral or fixed position, of about 0 mm to about 20 mm from the cutting edge 55 of the blade 58 and more preferably about 0 mm to about 10 mm and even more preferably about 0 mm to about 2 mm. The center longitudinal axis 66 may be positioned at a distance “d2”, in a forward pivot position, of about 0 mm to about 20 mm from cutting edge 55, and more preferably about 0 mm to about 10 mm and even more preferably about 0 mm to about 2 mm. The center longitudinal axis 66 may be positioned at a distance “d3”, in a rearward pivot position, of about 0 mm to about 20 mm from the cutting edge 55, and more preferably about 0 mm to about 10 mm and even more preferably about 0 mm to about 2 mm. In certain embodiments, the center longitudinal axis 66 may pass through the pivot axis 68.

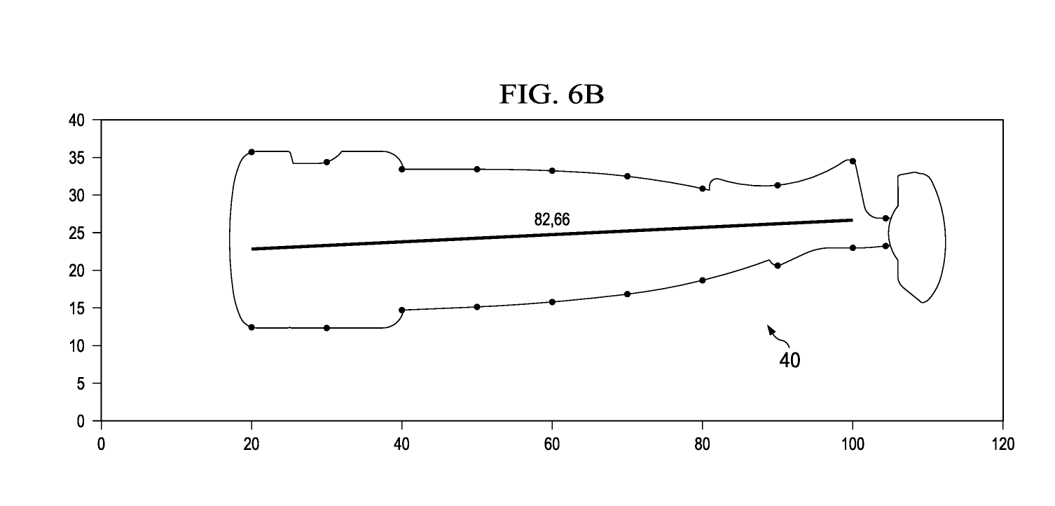

It is understood that not all shaving razors or shaving razor handles will be perfectly symmetrical. Accordingly, the center longitudinal axis can be calculated for any shaped razor handle. Referring to FIGS. 6A and 6B, side views of the shaving razor system 40 of FIG. 3 is shown on a grid. The side profile of the shaving razor system 40 may be taken from a photograph, an orthographic computer aided designs (CAD), or the shaving razor system 40 may be scanned or traced onto a grid. The grid may have an X axis and a Y axis with units at regular intervals and at the same scale. For example, FIG. 6A shows both the X and Y axis having a grid line every 10 units. Co-ordinates are plotted at regular intervals along the handle's upper profile 74 and lower profile 76. A minimum of ten points should be plotted for both the handle's upper and lower profile at regularly spaced out intervals from a distal end 78 of a first contact point 80 between the handle 44 and the cartridge 42. For example, every time a coordinate is taken on the handle's lower profile, a corresponding point is taken at the handle's upper profile. A software package such as, Microsoft Excel, can be used to plot a linear trend line 82 between the points defines the center longitudinal axis 66. Alternatively, the Least Square Method can be used to calculate the ‘line of best fit’ through the handle profile co-ordinates. This line of best fit defines the center longitudinal axis. The calculation for the Least Square Method is shown below.

$$\overline{X} = \frac{\text{?} \text{?}}{\text{?}}$$

$$\overline{Y} = \frac{\text{?} \text{?}}{\text{?}}$$

$$\text{?} \text{indicates text missing or illegible when filed}$$

$$m = \frac{\text{?} ( \text{?} - \overline{X} ) ( \text{?} - \overline{Y} )}{\text{?} {( \text{?} )}^{2}}$$

$$\text{?} \text{indicates text missing or illegible when filed}$$

It is understood that using a scanned image and plotting more points will provide more accurate readings. However, a photographed image and using a minimum of ten points is acceptable. Accordingly, reasonable tolerances are allowable for the trend line 82.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor system comprising:
a handle having a center longitudinal axis;
a shaving cartridge is mounted to the handle, the shaving cartridge having a guard and a cap defining a shaving plane and at least one blade having a cutting edge between the guard and cap, wherein the shaving razor cartridge has a neutral position with the shave plane within seven degrees of being perpendicular to the center longitudinal axis.

2. The shaving razor system of claim 1 wherein the shaving razor cartridge has a pivot axis aligned with the center longitudinal axis.

3. The shaving razor system of claim 1 wherein the shaving cartridge has a forward pivot position and a rearward pivot position.

4. The shaving razor system of claim 1 wherein the shaving razor cartridge has an ultimate forward pivot position up to 25 degrees.

5. The shaving razor system of claim 1 wherein the shaving razor cartridge has an ultimate rearward pivot position up to 25 degrees.

6. The shaving razor system of claim 1 wherein the shave plane intersects the center longitudinal axis less than 20 mm from the cutting edge of the blade.

7. The shaving razor system of claim 1 wherein the shave plane intersects the center longitudinal axis less than 10 mm from the cutting edge of the blade.

8. The shaving razor system of claim 1 wherein the shave plane intersects the center longitudinal axis less than 2 mm from the cutting edge of the blade.

9. The shaving razor system of claim 1 wherein the center longitudinal axis is spaced apart from the pivot axis by a distance of 0 to 10 mm.

10. The shaving razor system of claim 1 wherein the center longitudinal axis is spaced apart from the pivot axis by a distance of 0 to 2 mm.

11. The shaving razor system of claim 1 wherein the center longitudinal axis passes through the at least one blade.

12. The shaving razor system of claim 1 wherein the shaving plane intersects the center axis less than 20 degrees in an ultimate forward pivot position.

13. The shaving razor system of claim 1 wherein the shaving plane intersects the center axis less than 20 degrees in an ultimate rearward pivot position.

14. The shaving razor system of claim 1 wherein the center longitudinal axis passes between a point on the cap tangent to the shave plane and a point on the guard tangent to the shave plane.

15. The shaving razor system of claim 1 further comprising a coupler having an attachment mechanism that is aligned with the center longitudinal axis.

16. The shaving razor system of claim 1 wherein the shave plane intersects the center longitudinal axis between the cap and the guard.

17. A shaving razor system comprising:
a handle having a center longitudinal axis;
a shaving cartridge is mounted to the handle, the shaving cartridge having a guard and a cap defining a shaving plane and at least one blade having a cutting edge between the guard and cap, wherein the center longitudinal axis of the handle intersects the shave plane less than 10 mm from the cutting edge.

18. The shaving razor system of claim 17 wherein the center longitudinal axis of the handle intersects the shave plane between the guard and the cap.

19. The shaving razor system of claim 17 further comprising a coupler attaching the shaving razor cartridge to the handle, wherein the coupler comprises a finger pad with a concave top surface with a leading edge.

20. The shaving razor system of claim 19 wherein the leading edge is spaced apart from the intersection of the center longitudinal axis of the handle and the shaving plane by 5 mm to 20 mm.
